(19) United States
(12) Patent Application Publication
(10) Pub. No.: US 2026/0316164 A1
(43) Pub. Date: Oct. 15, 2026

(54) A MACHINING TOOL FOR CREATING OPENINGS IN A MULTI-LAYERED MATERIAL

(71) Applicant: THE UNIVERSITY OF SHEFFIELD, Sheffield (GB)

(72) Inventors: Robert Edward BRAMLEY, Catcliffe, Rotherham (GB); Peter Lawrence CRAWFORTH, Catcliffe, Rotherham (GB)

(21) Appl. No.: 19/122,644

(22) PCT Filed: Oct. 12, 2023
(86) PCT No.: PCT/GB2023/052648

§ 371 Date: Apr. 18, 2025

(30) Foreign Application Priority Data
Oct. 21, 2022 (GB) 2215616.0

(51) Int. Cl. B23B 51/00; B23B 47/34; B23B 51/06

(52) U.S. Cl. CPC B23B 51/0003; B23B 47/34; B23B 51/06; B23B 2215/04; B23B 2226/275; B23B 2228/36

(57) ABSTRACT

A machining tool for creating openings in a multi-layered material is provided. The tool comprises a main body comprising a coupling and a cutting head at one end thereof, the cutting head having a cutting diameter, at least one cutting edge and at least one outer corner, and a shroud having an average shroud wall thickness, a length, a distal end, a proximal end having a front edge, an internal shroud diameter and an external shroud diameter, said shroud covering at least part of the region between the coupling and cutting edge and configured to direct contaminants away from the opening. The internal shroud diameter increases towards the proximal end such that, in use, the shroud is tapered in the direction of the cutting head. The cutting diameter is greater than the external shroud diameter at the proximal end.

This invention relates to a machining tool for creating openings in a multi-layered material, to a method of creating such openings, and to a use of the machining tool in a one-way assembly process, for example in the manufacture of an aircraft.

### BACKGROUND

Hundreds of millions of fastener holes, or openings, are made in aircraft each year during the assembly process. As openings are a tight fit to their respective fasteners, openings in mating components, or otherwise interchangeably referred to as layers, must align extremely well to allow fit. This leads to openings typically being made through assemblies made of multi-layered material while the components are held together as a stack. Typically, multiple components are stacked together and a fastener hole is drilled through all of the layers at the same time.

Such material stacks increasingly consist of components having mixed metallic and fibre reinforced polymer (FRP) materials; this along with gaps between components due to poor fit up, challenging machining dynamics and stringent quality requirements, presents a significant challenge when creating openings in a stack of components. Components are therefore normally disassembled, inspected, and where necessary reworked before a fastener can be fitted. This extra work slows production rate while expensive jigs, fixtures and additional factory floorspace are occupied.

Some methods to address these issues include machining final holes through components individually, accurately enough so that holes align when assembled. However, such methods inherently lead to misalignment between the holes. These methods may be termed one-way assembly as the components are only stacked once, after the holes have been machined.

Another form of one-way assembly (OWA), also known as one-up assembly that eliminates the need to disassemble part-way through the process includes machining holes through the stack of components such that alignment is ensured and such that the machined holes are free from defects that would need corrective action requiring component separation. After decades of research to try and achieve an automated, reconfigurable, and flexible OWA solution, it is still considered a very high priority research area by the industry.

The gap between the layers in a multi-layered material (or between components in a stack of components) is known as the interfay and for OWA processes, a gap filler, or otherwise interchangeably referred to as sealant, is generally applied prior to assembly of components and machining holes. For OWA processes, it is preferred to machine holes with the sealant in a liquid state before it cures. Contamination of the interfay and damage to the sealant that fills the interfay are substantial technical barriers to implementing OWA.

Damage to the sealant is typically in the form of removal of sealant from the interfay. Swarf and conventional cutting fluids are considered contaminants. Swarf includes, but is not limited to, material removed from metallic and FRP materials (e.g. chips and dust). Contaminants can remain between the layers, in the interfay, or on the surface of the opening after machining, thereby contaminating the opening. Gaps between components are the norm and if there is a gap, contaminants can enter and the sealant can be damaged with conventional tool geometry. In view of this, little coverage of contaminant-free machining and sealant damage prevention for OWA applications has been seen in literature.

Other hole defects include: contamination on the surface of the hole, hole geometry errors, burrs, metallic caps, uncut FRP fibres, attrition of FRP (typically by metallic swarf), FRP delamination and sub-surface cracking, FRP surface defects (e.g. pitting, matrix smearing, matrix coating), gouging/scoring of surfaces, poor surface finish (roughness and waviness), metallic microstructural defects and FRP heat affected zone (HAZ).

Clamping of the stack of the components is a solution currently used in industry that includes such alternatives as using adjacent final fasteners, disposable rivets, C-clamps, electromagnetic clamping to hold the layers together. Non-liquid sealants or adhesives have also been used to reduce interfay contamination. All these methods have drawbacks and provide little protection from the contaminants to the walls of the stacked fastener holes as they only protect the interfay from contamination by minimising the gap thickness or preventing flow of contaminants through a liquid gap filler. Other efforts to achieve holes suitable for OWA have included: laser and waterjet cutting, vacuum extraction of swarf, use of non-contaminating cutting fluids, machining parameter optimisation, alternate tool paths, optimisation of traditional cutting tool geometry and optimisation of material grades and coatings.

One known way to provide an opening in a multi-layered material is disclosed in U.S. Pat. No. 4,966,503. The drill bit for drilling holes in a layered material is provided with a collar fixed to the outer surface to prevent chips from contacting the bore drilled in the first layer. There is however a large gap between the collar and outer corner of the cutting edge in the axial direction and a lack of geometry for guiding contaminants inside the collar. The collar therefore does not provide full protection against contamination of the opening and interference with sealant at the interfay. Furthermore, the outer diameter of the collar is of equal diameter to the cutting teeth of the drill, and therefore the diameter of the opening, this would cause undesirable rubbing between the collar and opening, exacerbated by thermally driven contraction of the hole diameter caused by heat from the drilling process, mechanical deformation around the bore surface (spring back) and thermal expansion of the cutting tool.

It is therefore an object of embodiments of the invention to at least mitigate one or more of the problems associated with the prior art.

### BRIEF SUMMARY OF THE DISCLOSURE

In accordance with the present invention there is provided a machining tool for creating openings in a multi-layered material, the tool comprising:
a main body comprising a coupling, and
a cutting head at one end thereof, the cutting head having a cutting diameter, at least one cutting edge and at least one outer corner; and
a shroud having an average shroud wall thickness, a length, a distal end, a proximal end having a front edge, an internal shroud diameter and an external shroud diameter, said shroud covering at least part of the region between the coupling and cutting edge and configured to direct contaminants away from the opening,
   wherein the cutting diameter is greater than the external shroud diameter at the proximal end.

It will be appreciated that the cutting diameter of the cutting head is defined by the at least one outer corner. In particular, the cutting diameter is defined by the position of the at least one outer corner relative to the tool's axis of rotation. Therefore, the external diameter of the shroud at the proximal end is less than the diameter of the at least one outer corner. The external diameter of the shroud at the proximal end is therefore less than the size of the opening created by the tool during use.

Advantageously, having a cutting diameter that is greater than the external shroud diameter at the proximal end allows the shroud to pass through the opening and reduces rubbing and interference between the shroud outer wall and the wall of the opening. This is particularly advantageous when creating an opening in a fibre-reinforced polymer (FRP) material as such rubbing can damage the FRP material, for example by creating matrix smearing, heat affected zone or delamination. In addition, when the machining tool is used to create an opening through a multi-layered material (e.g., a stack of components) the shroud acts to protect the interfay(s) between the components to prevent ingress of contaminants and to prevent damage to any sealant provided in the interfay (e.g., curable sealants, or tapes, in the interfay). Therefore, the machining tool is particularly suited to one-way assembly because an opening can be made through a multi-layered material comprising a stack of components without damaging or contaminating the openings, removing the need to disassemble, clean, and/or re-machine the openings.

Additionally, the shroud protects the bore of the opening from being damaged by swarf. In particular, the shroud prevents swarf from passing between the tool and the opening, which may protect against surface defects, gouging and scoring, and delamination caused by swarf dragging. This improves the geometry of the opening.

In an example, the internal shroud diameter increases towards the proximal end. In particular, the shroud comprises a taper that is tapered in the direction of the cutting head. Specifically, the cross-sectional area defined within the shroud increases towards the proximal end, specifically by a tapering of the shroud wall thickness. This increases the internal size of the shroud at the proximal end to capture more contaminants generated at the cutting head.

In an example, the proximal end of the shroud may comprise a taper extending partially or entirely about the circumference. In an example, the taper may extend only partially about the circumference, and in such examples the taper is preferably located adjacent to the outer corner, in particular in front of the outer corner relative to the rotational direction of the machining tool during use. Advantageously, the taper would therefore be located where the cutting edge is forming contaminants (e.g., a chip (swarf) or dust) as the workpiece material is cut, and the taper helps to guide the contaminants into the internal diameter of the shroud. Where the machining tool comprises a plurality of outer corners, the shroud may include a taper for each outer corner.

Advantageously, the presence of the taper guides contaminants into the shroud and away from the opening and interfay, preventing contamination and damage to any sealant provided in the interfay. In particular, the taper at the proximal end of the shroud urges contaminants inwardly, into the shroud, and therefore prevents the contaminants passing between the outside of the shroud and the uncut workpiece material. This protects surfaces of the opening from abrasion and contamination and also protects the interfay(s) when the machining tool is used with a multi-layered material, such as a stack of components. Additionally, the taper prevents build-up of cut material against the front of the shroud, helping with evacuation of contaminants, and reducing cutting forces. The taper also allows the front edge of the shroud to be a close fit to the outer corner and reduces heat build-up, tool wear, burr formation and FRP delamination.

In another embodiment, the taper has a chamfer, bevel or fillet. Advantageously, this is a simple form to manufacture, whilst still providing the benefits associated with the general taper form.

In another embodiment, the cutting head and the shroud are integral with the main body. Advantageously, this embodiment makes it easier to control runout of the cutting head and shroud.

In another embodiment, the cutting head, the shroud and the main body are formed as a multipiece arrangement. For example, the cutting head may be a replaceable cutting head, and the replaceable cutting head may be attachable to the shroud, for example by a thread, spline attachment, brazing, welding, adhesive, polygonal clamping, or interference (shrink) fit. Advantageously, this makes internal features easier to access during manufacture and can allow for components (in particular the replaceable cutting head) to be replaced if worn. It also allows for cheaper, more easily manufacturable materials to be used where possible and harder materials to be used in regions where the tool wears.

In preferred examples the front edge of the shroud is located proximate to the outer corner of the cutting head in an axial direction along the tool. That is, the front edge of the shroud, optionally with a taper, is close to the outer corner of the cutting head. In this way, cut material passes directly into the shroud and does not pass between the shroud and the uncut workpiece material, and into the interfay or against the bore surface, and also so as not to damage any sealant that may be present.

In an embodiment, the shroud covers the region located less than 1 mm axially from the at least one outer corner of the tool and wherein the region is circumferentially aligned with the at least one outer corner of the tool. That is, the front edge of the shroud is axially spaced from the at least one outer corner by less than 1 mm in the distal direction. In other examples, the front edge of the shroud is axially spaced from the at least outer corner by less than 0.6 mm, for example less than 0.3 mm, for example between about 0.3 mm and about 1 mm, for example between about 0.3 mm and about 0.6 mm. Advantageously, these embodiments best prevent contamination of the opening because contaminants are not able to enter the space between the external diameter of the shroud and the opening, so are forced into the shroud.

In embodiments, an axial offset between the at least one outer corner of the tool and the front edge of the shroud is less than 1 mm, preferably less than 0.6 mm, more preferably less than 0.3 mm. Advantageously, this best prevents contamination of the opening because contaminants are not able to pass between the shroud and the outer corner, and into the interfay or against the bore surface.

In another embodiment, the outer diameter of the shroud at the proximal end is less than 0.16 mm smaller than the cutting diameter, preferably less than 0.08 mm smaller than the cutting diameter, more preferably less than 0.03 mm smaller than the cutting diameter, more preferably less than 0.02 mm smaller than the cutting diameter, more preferably less than 0.01 mm smaller than the cutting diameter. In examples, the outer diameter of the shroud at the proximal end is less than 0.160 mm smaller than the cutting diameter, preferably less than 0.080 mm smaller than the cutting diameter, more preferably less than 0.030 mm smaller than the cutting diameter, more preferably less than 0.020 mm smaller than the cutting diameter, more preferably less than 0.010 mm smaller than the cutting diameter. In examples, the outer diameter of the shroud at the proximal end is between 0.01 mm (0.010 mm) and 0.16 mm (0.160 mm) smaller than the cutting diameter, preferably between than 0.08 mm (0.080 mm) and 0.16 mm (0.160 mm) smaller than the cutting diameter, more preferably between 0.03 mm (0.030 mm) and 0.08 mm (0.080 mm) smaller than the cutting diameter, more preferably between than 0.02 mm (0.020 mm) and 0.08 mm (0.080mm) smaller than the cutting diameter, more preferably between 0.01 mm (0.010 m) and 0.08 mm (0.080 mm) smaller than the cutting diameter.

Advantageously, these examples prevent contamination of the opening because contaminants are not able to enter the space between the external diameter of the shroud and the opening, so are forced into the shroud. The smaller the difference between the external diameter of the shroud and the cutting diameter, the less contaminants will be able to pass between the shroud and the opening. However, this is balanced against the likelihood of the shroud contacting the opening during use. The inventors have found the above dimensions to perform well in use on a multi-layered material, in particular when machining an opening in a stack of components for one-way assembly.

In an embodiment, the shroud covers the region less than 0.6 mm from the cutting edge in any direction, preferably less than 0.3 mm. In examples, the shroud covers the region less than 0.6 mm from the at least one outer corer in any direction, preferably less than 0.3 mm.

In other examples, the proximal end of the shroud is axially offset from the at least one outer corner by less than 0.6 mm, preferably less than 0.3 mm, and the outer diameter of the shroud at the proximal end is less than 0.6 mm smaller than the cutting diameter (diameter of the outer corner), preferably less than 0.3 mm.

This ensures that the proximal end of the shroud is as close as possible to the at least one cutting edge (and at least one outer corner) to ensure that contaminants are forced into the shroud and do not enter between the external surface of the shroud and the opening where they may cause damage and/or contamination.

In an embodiment, the cutting diameter of the tool is less than 50 mm. Advantageously, this is an appropriate size for the majority of aerospace fastener holes.

In another embodiment, the average shroud wall thickness is less than 0.3 mm. Advantageously, such thickness helps prevent clogging of the shroud by providing a bigger cross-sectional area for swarf to travel up.

In another embodiment, the internal shroud diameter increases between the proximal end and the distal end. That is, the internal shroud diameter at the distal end is greater than the internal shroud diameter at or near the proximal end (excluding the taper used to guide contaminants). The increase in the internal shroud diameter may be provided by a taper, for example a gradual taper extending over a substantial portion of the length of the shroud, or by one or more steps. Such an increase in the internal diameter of the shroud creates a drafted passage for extracting contaminants. The drafted passage may ease extraction and prevent clogging by reducing friction forces between the passage and material being extracted.

In examples, an external shroud diameter at the proximal end is greater than an external shroud diameter at the distal end. That is, the external diameter of the shroud decreases in the distal direction. The decrease in external diameter may be provided by a step, taper, or similar. The decrease in the external diameter may prevent distal parts of the shroud from contacting the opening, while providing a (relatively) larger external shroud diameter close to the cutting head to prevent contaminants from entering between the shroud and the opening.

In yet another embodiment, the shroud further comprises an outer wall (outer surface), wherein said outer wall comprises a rough, abrasive, surface. Advantageously, the presence of the abrasive surface helps to collect contaminants during the drilling process and remove uncut fibres if a fibre-reinforced polymer material is being cut.

In an embodiment, the shroud comprises an outer wall with a patterned surface, for example a rough or abrasive surface. In examples, the patterned surface comprises a plurality of depressions or grooves. Advantageously, this enables a tight fit to the opening while reducing friction. They also provide a place for any lost contamination to be recaptured. Grooves may have a wide width, in effect creating a margin as is commonly seen on twist drills. Grooves and depressions can also be shaped to assist with an aerodynamic air bearing effect between the shroud and bore surface of the opening to help guide the tool straight for hole generation processes where the tool is fed only in an axial direction. For example, the depressions or grooves may take the form of a spiral groove bearing.

In another embodiment, the front edge of the shroud is a shroud cutting edge that acts to cut material, in particular swarf. The shroud cutting edge may have a discontinuous profile comprising segments that are offset from each other, for example by way of steps or notches. Advantageously, in such embodiments, the shroud cutting edge may help to remove FRP fibres.

In another embodiment, the cutting edge on the cutting head has a sawtooth, wavy, or zigzag profile. Advantageously, in such embodiments, higher stresses are created in swarf, thereby assisting the breakup and extraction of the swarf.

In an embodiment, the tool comprises at least one fluid outlet located by the cutting edge, said at least one fluid outlet is configured to deliver a cutting fluid and to point towards the distal end of the tool. In another embodiment, the cutting fluid is in a supercritical state during use. Advantageously, this enables cooling and lubrication at the cutting interface whilst also assisting in chip and swarf removal as the cutting fluid is directed towards the interior of the shroud. Further advantageously, having the fluid outlet configured to point towards a distal end of the tool minimises contamination of the opening. Further advantageously, cutting fluids delivered in the supercritical state can change state into a gas under atmospheric conditions where they would not be considered a contaminant.

In examples, the tool further comprises at least one extraction channel, for example a flute, extending from the proximal end of the tool and at least partly through the internal diameter of the shroud. In examples, the extraction channel may be drafted so that it is larger at a distal end than at a proximal end, to encourage removal of contaminants through the extraction channel.

In an embodiment, the tool further comprises a web and at least one flute, said flute being at least partly enclosed by the shroud. The flute may be an extraction channel. Advantageously, the web adds stiffness to the tool and provides a convenient mounting point for the shroud. In examples, the flute may be straight or helical. In examples, the flute may be drafted so that it is larger at a distal end than at a proximal end, to encourage removal of contaminants through the flute.

In an embodiment, the cutting head has the geometry of a drill, a reamer, a trepanning tool, or a boring tool. In particular, the machining tool may be a drill or a reamer. Advantageously, this allows for effective removal of material when creating the opening (hole) while feeding the tool in the axial direction only. In other examples, the machining tool is a milling tool and so can be used to create the opening within a substantial range of diameters by feeding the tool in both axial and radial directions. In other examples, the machining tool is not a milling tool.

In some examples the tool further comprises a countersink cutter located on the tool distally of the cutting head. The countersink cutter is arranged to cut a countersink in the workpiece material after the opening has been machined, or during machining of the opening. This is particularly advantageous when the tool is used to machine fastener holes in a component as the hole can be machined and countersunk in a single machining operation.

In accordance with another aspect of the present invention there is provided a method of creating an opening in a multi-layered material comprising the steps of
Providing the multi-layered material;
Providing a tool as described above;
Performing a machining operation using the tool to create the opening, such that contaminants are directed away from the opening during the machining operation,
   wherein the opening is provided substantially free from contaminants.

Advantageously, such a method guides contaminants away from the opening, thus providing protection of the opening, interfay, and surfaces from contaminants and, in turn, improving contamination levels, sealant damage, FRP surface defects, surface gouging, delamination caused by swarf dragging, and the geometry of the opening.

In preferred examples, the multi-layered material comprises a stack of components. Each component may comprise a fibre-reinforced polymer (FRP) material (e.g., carbon fibre-reinforced polymer) and/or a metal material, such as aluminium, titanium, or steel. In examples, the stack of components may comprise a mix of FRP and metal materials. In examples, the method is a method of one-way assembly (OWA) of a stack of components where an opening is created through multiple components arranged in a stack. The opening may be a fastener hole. Advantageously, the machining tool urges contaminants through the shroud and prevents them from moving into the interfay and between the shroud and the opening, thereby preventing contamination of, and/or damage to, the opening and/or interfay as the opening is machined. This helps to prevent the need to disassemble the stack of components to finish the openings and clean contaminants from the interfay(s), enabling one-way assembly.

In an embodiment, providing the multi-layered material may comprise stacking a plurality of components. At least one of the components may comprise a fibre-reinforced polymer material, particularly carbon fibre-reinforced polymer material.

In an embodiment, the tool is a drill, a reamer, a trepanning tool, or a boring tool, and performing a machining operation comprises creating a hole by rotating the tool about its axis and moving the tool in an axial direction, in particular moving the tool only in an axial direction and not in a lateral direction to create a circular hole.

In an embodiment, the method may further comprise cutting a countersink during or after machining the opening. The countersink may be cut by a countersink cutter provided on the machining tool, spaced from the cutting head.

In an embodiment, the method may further comprise inserting a fastener through the opening without disassembly of the stack of components. That is, the method may be a method of one-way assembly.

In an embodiment, controlled vibration, such as that provided in vibration assisted machining, is applied to the machining tool. Advantageously, vibrating the tool during drilling further assists swarf breaking. Further advantageously, it reduces cutting temperatures thus reducing abrasive tool wear. Even further advantageously, it helps impart preferential compressive residual stresses in metallic components.

In another embodiment, the method further comprises a step of localised clamping to compress the layers of the multi-layered material together, for example to compress components of the stack of components together. Advantageously, using additional clamping reduces the size of gaps between layers (components), assisting with preventing contamination, burrs and FRP delamination at the interfay.

In yet another embodiment, the method further comprises the step of vacuum extraction of the contaminants. Advantageously, it provides efficient removal of contaminants under controlled conditions, especially when cutting fluid is used.

In an embodiment, the step of performing a machining operation is performed to widen a pre-existing opening such as a pre-hole or a defective hole. Advantageously, the method allows to provide contaminant-free, final-size, openings where temporary fasteners have been positioned to provide clamping, where there is already an undersized opening to minimise the amount of machining to be carried out in the assembly stage, or in areas where creation of a final-size opening has already been attempted but produced an opening with defects. In such examples the machining tool may be a trepanning tool or a boring tool.

In accordance with the present invention there is provided a use of the tool or the method as described above in a one-way assembly process. Advantageously, the use of the machining tool and the method described above allows to provide clean openings when a one-way assembly method is used, even if gaps are present at the interfay.

### BRIEF DESCRIPTION OF THE DRAWINGS

Embodiments of the invention are further described hereinafter by way of example only with reference to the accompanying drawings, in which:

FIG. 1 is a perspective view of a machining tool according to an embodiment of the present invention;

FIG. 1a is an end view of the machining tool depicted in FIG. 1;

FIG. 1b is a close up view of the machining tool depicted in FIG. 1 showing the outer corner;

FIG. 2 is a cross-sectional view of the machining tool depicted in FIG. 1;

FIG. 3a is a close up view of the machining tool showing the chamfer;

FIG. 3b is a close up view of the machining tool showing a change in the external diameter of the shroud, achieved by a step in the diameter;

FIG. 4 is a plain view of the machining tool according to an alternative embodiment of the present invention comprising grooves;

FIGS. 5 and 5a are plain and close up views of an embodiment of the present invention comprising at least one fluid outlet that points towards the distal end of the tool;

FIG. 6a shows a perspective view of an example machining tool having a multipiece construction;

FIG. 6b shows a cross-section of the machining tool of FIG. 6a; and

FIG. 6c shows a closeup view of the machining tool of FIGS. 6a and 6b.

### DETAILED DESCRIPTION

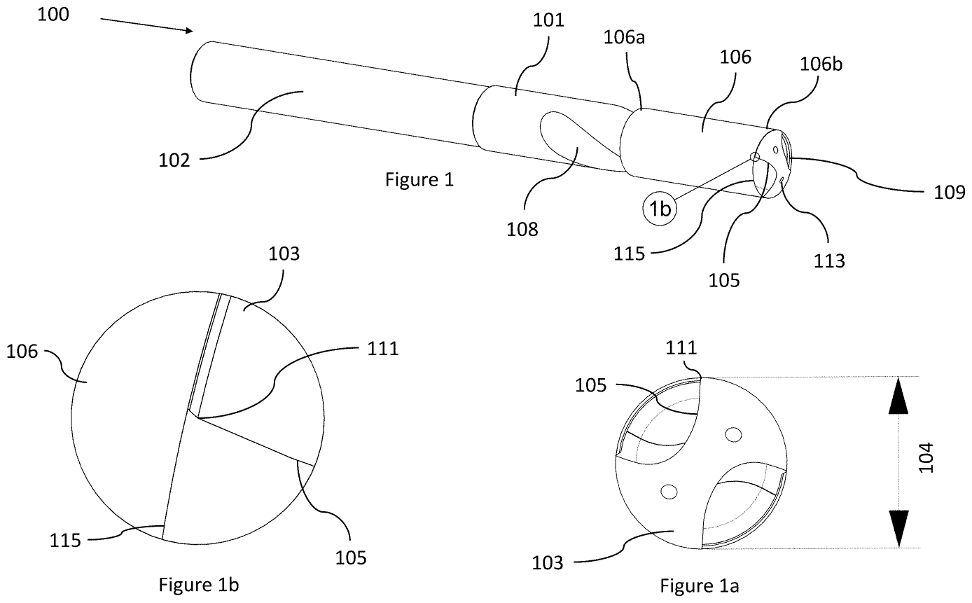

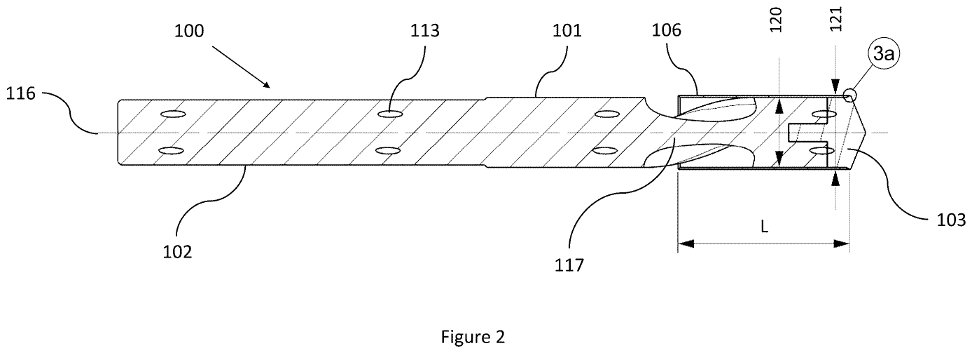

FIG. 1 shows a machining tool 100 according to an embodiment of the present invention, FIG. 1a, FIG. 1b and FIG. 2 are an end view, close up view and cross-sectional view, respectively, of the same embodiment. The tool has an elongated main body 101 that has a coupling 102 at its distal end and a cutting head 103 at its proximal end. In this example the tool 100 is a drill and the cutting head 103 includes a drill tip. However, in other examples the tool 100 may be a reamer and the cutting head 103 may include cutting geometry of a reamer, or the tool 100 may be a trepanning tool or a boring tool.

The tool 100 could be made from a variety of materials (for example, cemented carbide, tool steel, high speed steel), with hard materials being more suitable for the cutting head 103. Various wear resistant coatings (for example, diamond coatings) could also be applied to decrease wear in use. Similarly, various low friction coatings may be applied to reduce friction. The cutting head 103 has a cutting diameter 104 and at least one cutting edge 105. The cutting diameter 104 may be less than 50 mm. It is understood that the geometry around the cutting edges can take a variety of forms known in the art, for example, various rake and clearance angles, various profiles of the cutting edge and, for drills, various chisel designs are possible.

It will be understood by the skilled person that the term “distal” defines the location of any part of the tool that is situated away from the drilling area, and the term “proximal” defines the location of any part of the tool that is situated towards or adjacent to the drilling area.

The machining tool 100 further has a shroud 106 that is located at the proximal end of the tool 100 and is configured to at least partly cover the region along the tool axis 116 in the distal direction from the cutting edge 105. The axial offset between the shroud front edge 115 and the outer corner 111 of the tool is minimised to best contain contamination however, remains big enough such that the shroud front edge 115 does not contact uncut material. To avoid contact between the shroud front edge 115 and uncut material during use, the size of the axial offset should be at least the axial feed per tooth of the tool plus the amplitude of any axial vibration between the tool and workpiece. Having this axial offset gives swarf a distance over which it can move radially inwards before contacting the shroud front edge 115. The shroud 106 covers the region circumferentially aligned and within 1 mm axially of the outer corners 111 of the tool 100, preferably within 0.6 mm, or within 0.3 mm. That is, the shroud front edge 115 is in close proximity with the outer corner 111 of the cutting head 103. In conventional tools the shroud would not cover this region due to potential to interfere with the formation of swarf at the cutting edge 105. However, in the tool 100 by covering this region with the shroud 106 contaminants that slide along the rake face of the tool near the cutting edge 105 are advantageously captured and guided into the shroud 106.

The proximity of the shroud front edge 115 to the cutting edge 105, in particular the outer corner 111, prevents contaminants created during machining from passing between the shroud 106 and the uncut workpiece material, and can therefore prevent damage to the opening and contamination of the interfay when a multi-layered material is being machined.

The external diameter 121 of the shroud 106 is maximised in order to best capture contamination and prevent swarf catching on the shroud front edge 115; however, it remains far enough under the cutter diameter 104 of the tool to prevent interference with the wall of the opening. To prevent interference between the external diameter of the shroud and the wall of the opening, the offset between the cutting diameter and shroud outer wall should be greater than the amount of contraction seen in openings as FRP and metallic layers contract during the hole generation process due to thermal effects and mechanical spring back and also account for thermal expansion effects of the tool when, for example, the cutting head 103 and the shroud 106 are made from dissimilar materials. For an axial hole generation process, a margin is often used on the tool to help guide it straight and achieve desired hole tolerances. With a shroud 106 in place, it is not possible to have a substantial margin along a flute edge. Instead, a close fit between the shroud 106 and cutting diameter 104 is used to guide the tool straight. A close fit can produce an aerodynamic air bearing effect.

As the cutting edge 105 wears, the offset would be reduced, the axial offset would also be reduced if the tool underwent regrinds to sharpen it. Additional axial offset between the shroud front edge 115 and the cutting edge 105 can be provided to accommodate for wear and regrinds. Without adequate offsets between the shroud and outer corner, rubbing, forces and heat generation would be increased which have a deleterious effect on tool life and hole quality.

The shroud 106 has a shroud wall thickness 107 and a length L. The wall thickness can be in the range of, but is not limited to, 0.1-0.3 mm. The length of the shroud can be such that it is long enough to extend beyond the depth of the opening to protect the opening from contaminants. In this case it allows air to circulate underneath cut material as it exits the shroud, and clear it by a vacuum, so that the dust does not settle on the top surface of the workpiece as is normal when drilling openings. A thin wall thickness 107 provides greater cross-section for swarf to travel along. Additionally, a thin wall thickness 107 provides a smaller area at the front of the shroud 106 for swarf to catch on, thereby reducing cutting forces and heat generation which would a deleterious effect on tool life and hole quality.

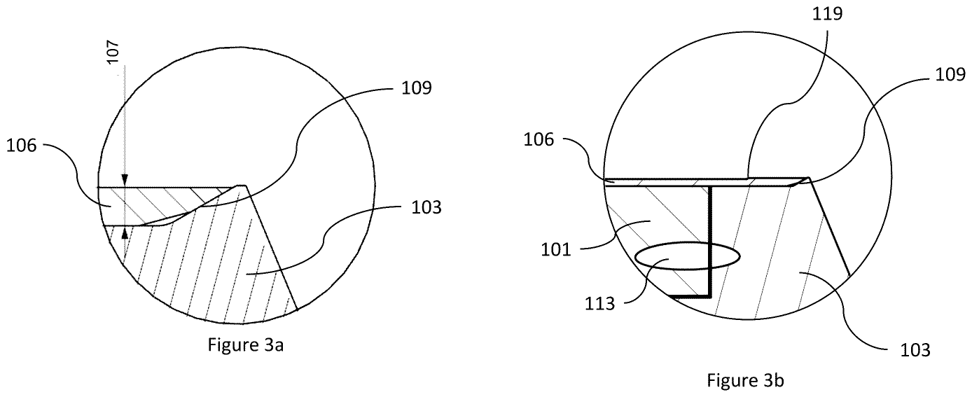

The shroud 106 has internal 120 and external 121 shroud diameters, a distal end 106a and a proximal end 106b. It will be understood that the internal shroud diameter 120 increases towards the proximal end (shroud front edge 115) such that the shroud wall thickness tapers. A chamfer 109, shown in FIG. 3a is the preferred embodiment of the taper. The chamfer 109 guides contaminants from the cutting edge 105 into the shroud 106 and thereby also helps to prevent contaminants created during machining from passing between the shroud 106 and the uncut workpiece material. The chamfer 109 helps prevent swarf catching and pushing on the front of the shroud 106, thereby reducing heat build-up, tool wear, burr formation and CFRP delamination. In examples where the shroud 106 is a separate piece to the cutting head 103, this increases the strength of the cutting head 103 at the outer corner 111.

It is also understood that the difference in the external distal and proximal shroud diameters, shown in FIG. 3b, can be a result of having different wall thickness 107 at the distal end 106a and the proximal end 106b of the shroud 106. However, it is also possible that the wall thickness 107 remains constant and the external diameter of the shroud 106 at its distal end is smaller than the external diameter at its proximal end. In other words, the former describes an embodiment wherein an inner diameter of the shroud remains constant, whereas the latter describes the shroud with constant wall thickness and changing inner shroud diameter.

Optionally, the main body 101 and cutting head 103 can have a web 117 and at least one flute 108. The at least one flute 108 can be helical or straight. The shroud 106 may at least partially cover the at least one flute 108. A distal end of the at least one flute 108 is open (not covered by the shroud 106) to allow extraction of contaminants from the flute 108. In some examples the at least one flute 108 may be drafted, with a smaller size at the proximal end and a larger size at the distal end. Such drafting can assist in extraction of contaminants, for example when vacuum is applied to the distal end of the at least one flute 108. However, it is also understood that the web 117 and at least one flute 108 may not be present, or may not be present over a substantial length of the shroud. In such examples the shroud 106 may include a hollow portion and there may be a space between the cutting head 103 and the main body 101, within the shroud 106, that defines an extraction channel for extracting contaminants. In such examples, the extraction channel may be drafted.

FIG. 3a shows the close up, cross-sectioned, view of the proximal end of the shroud 106 according to the present invention. The shroud 106, as described above, covers at least part of the region along the tool axis in the distal direction from the cutting edge 105. The shroud outer diameter at its proximal end 106a is smaller than the cutting diameter 104 of the cutting head 103 such that rubbing between the shroud 106 and the bore surface of the opening is reduced during use. As shown, the distal side of the cutting head 103 may optionally be tapered where the chamfer 109 abuts it. The chamfer 109 (and the optional corresponding taper on the cutting head 103) permits the shroud front edge 115 to be in close proximity to the outer corner 111 of the cutting edge 105 as previously described. Where the chamfer 109 aligns with a flute 108 the chamfer 109 also acts to guide contaminants into the shroud 106 and increases the strength of the outer corner of the cutting head 103.

It will be understood by a skilled person that the chamfered interface between the shroud 106 and the cutting head 103 only exists for arrangements where the cutting head 103 and shroud 106 are separate pieces. In some examples the shroud 106 and cutting head 103 are formed of a single piece and in such examples the chamfer 109 is only present where there is an extraction channel, for example where the at least one flute 108 is provided. It will also be understood that chamfer-like geometries fulfilling the same function can be formed instead. Such structures can be, without limitation, a bevel, a fillet or a freeform profile.

In an alternative embodiment, as shown in FIG. 3b, the external diameter of the shroud 106 changes. The change is shown as a step 119 in FIG. 3b. Thus, the external diameter at the distal end 106a of the shroud 106 is smaller than the external diameter at the proximal end 106b. In this embodiment the cutting diameter 104 is still greater than any of the diameters of the shroud 106. A chamfer 109 is formed at the interface of the shroud 106 and the cutting head 103 as described above. Having the cutting diameter 104 bigger than the maximum external diameter of the shroud 106 can reduce contact between the shroud 106 and the wall of the opening during use. The step 119 in the outer diameter of the shroud 106 provides additional clearance between the shroud 106 and the hole wall in the material being machined. It is further understood that other features, such as a fillet or gradual taper for example, can be used instead of stepped profile 119, fulfilling substantially the same function.

In the prior art machining tools such as those described above (for example, U.S. Pat. No. 4,966,503), when the cutting tool is rotated by a powered rotary device to create an opening in a multi-layered material, the contaminants are formed during drilling. These contaminants can contaminate the surfaces of the opening and the interfay, as well as create such defects as scratching and/or gouging.

In the machining tool 100 of FIGS. 1-5, the swarf and other contaminants are guided away from the inner walls of the opening as the shroud 106 creates a barrier between the contaminants and the opening. It is advantageous to have the chamfer 109 at the shroud front edge, rather than a flat edge as seen in prior art, as this guides contaminants inside the shroud, and for embodiments where the cutting tip is a separate piece to the shroud, it allows the front edge of the shroud to be in close proximity to the outer corner of the cutting tip while maintaining the strength at the outer corner. Guiding contaminants inside the shroud will provide a clean interface between stack layers. Such a result is particularly beneficial in one-way assembly when all the layers of the material are stacked together and drilled simultaneously when stacked, without the need for intermediate disassembly to evaluate and improve quality of the openings before fitting a final fastener. Furthermore, having the shroud 106 in place adds extra stiffness to the tool 100 and, in turn, enables the use of thinner than standard webs of the cutting tool, or no web 117. Reduction of the web provides a greater cross-sectional area for swarf removal.

In the embodiment described above, the main body 101, cutting head 103 and shroud 106 are separate pieces. In alternative embodiments, these pieces can be united into one in various combinations. For example, in an alternative embodiment, the shroud 106 can be integral with the main body 101, they can be machined or 3D-printed as one piece. As a further example, it can be produced using a mould, e.g. carbide powder is formed to the desired shape in the “green state” and then sintered. In alternative embodiments, these pieces can be broken down into further sub-components. For example, the cutting head can include inserts with an additional interface to connect them to the cutting head.

It is understood, that when the shroud 106 is not integral with the main body 101 and cutting head, the shroud can be retrofitted to existing tools by grinding the geometry that interfaces with the shroud and fitting the shroud in place. The fitting process can be, for example as follows: the shroud is pre-heated and fitted onto the main body 101 from the coupling 102 end. The shroud 106 is then progressed further towards the distal end of the tool 100 until the shroud touches the chamfer 109. As the final stage, the shroud cools and shrinks to fit the tool 100. It is understood that other alternative fitting methods are also contemplated.

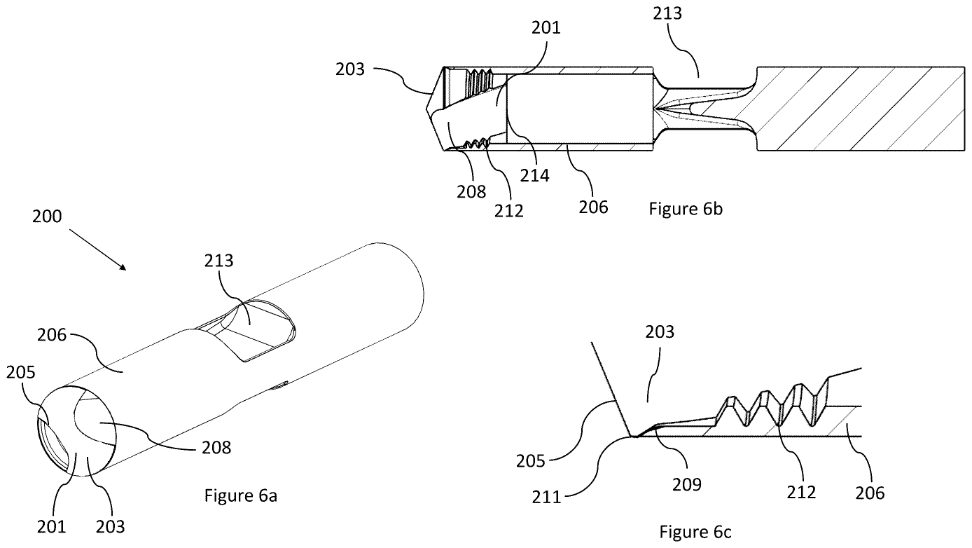

FIGS. 6a-6c show an example tool 200 with a multi-piece construction. In this example a substantial section of the swarf passage is without a web or flute. In this example a two-piece construction is shown. FIG. 6a shows a perspective view of the tool 200, FIG. 6b shows a longitudinal cross-section through the tool 200 and FIG. 6c shows a close up sectional view of the proximal end of the shroud. The tool 200 comprises a removable cutting head 201 and a shroud 206. In this example, the removable cutting head 201 attaches to a proximal end of the shroud 206. In this example the removable cutting head 201 is a drill cutting head, but in other examples it may be a reamer cutting head, a trepanning tool cutting head, a boring tool cutting head, or a milling cutting head.

As illustrated, the removable cutting head 201 includes a cutting head 203 with a cutting edge 205 having an outer corner 211. The cutting head 203 is substantially as described above in relation to previous examples. The shroud 206 is attachable to the removable cutting head 201 to at least partly cover the region along the tool axis in the distal direction from the cutting edge 205. As shown, the shroud 206 is attached to the removable cutting head 201 by a thread 212. Alignment surfaces are also used for accurate positioning. The thread 212 is preferably located towards the proximal end of the shroud 206 so as to reduce the distance between the thread 212 and the proximal end of the shroud 206 and thereby increase the stiffness of the proximal end of the shroud 206. Alternative methods of attaching the removable cutting head 201 to the shroud 206 are possible; for example, the use of splines, brazing, welding, adhesives, shrink fit connections and polygonal clamping. It will also be understood by the skilled person that certain combinations of these attachment methods could be used.

Having the connection between the removable cutting head 201 and shroud 206 close to the proximal end of the shroud 206 also allows for a shorter removable cutting head 201 and therefore a longer proportion of swarf passage without the restriction of a web.

In this example the removable cutting head 201 extends only partly into the shroud 206 and has a distal end 214 located within the shroud 206 as shown in FIG. 6b. The shroud 206 provides a coupling when using the tool 200. Accordingly, the tool 200 can be assembled by screwing the removable cutting head 201 into the shroud 206, and the removable cutting head 201 can be removed in the same way, for example to be exchanged with a new removable cutting head 201.

As shown, the removable cutting head 201 includes extraction passages, in this example flutes 208, that extend from the cutting head 203 to the distal end 214 of the removable cutting head 201 to permit swarf and other contaminants to pass from the cutting head 203 into the shroud 206 where they can pass out of the tool at openings 213. The flutes 208 may be straight (in the axial direction), or helical, and may be drafted (tapering). The flutes 208 are axially shorter in this example than in the examples of FIGS. 1 to 5, which may help prevent clogging and improve extraction of contaminants. In particular, the flutes 208 only extend the axial length of the removable cutting head 201 and beyond the removable cutting head 201 an extraction channel is defined within the shroud 206 as far as the openings 213. Therefore, in this example the flutes 208 extend only a short distance from the cutting edge 205 in the axial direction and are less prone to blockage. In this example an extraction passage is defined through the flutes 208 and through the shroud 206 to the openings 213.

As shown in FIG. 6c, and in the same manner as described with reference to other examples, the proximal end of the shroud 206 includes a chamfer 209 that engages a corresponding taper on the cutting head 203. As with the examples described above the proximal end of the shroud 206 is axially proximate to the outer corner 211 of the cutting edge 205 and spaced in the axial direction by less than 1 mm in the same way as described above for the examples of FIGS. 1 to 5. In addition, as described above the outer diameter of the shroud 206 is less than the cutting diameter in the same way as described above for the examples of FIGS. 1 to 5.

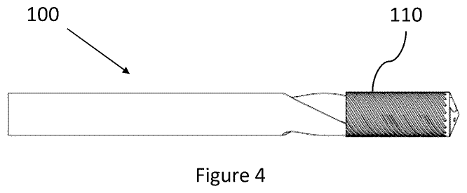

In another alternative embodiment, the shroud 106, 206 can have a rough, abrasive, outer surface. Advantageously, this may help with collecting contaminants and remove uncut fibres in FRP material. In yet another alternative embodiment, such as one shown on FIG. 4, the outer wall of the shroud 106 can have a plurality of grooves 110 or depressions, configured to minimise rubbing against the opening while maintaining a close fit. The purpose is to keep a tight fit to the opening while reducing friction. The grooves 110 could have a variety of forms, e.g. axial, helical, circumferential. Depressions could also have variation in geometry. The grooves or depressions work in a similar way to a margin on a drill or are configured to assist in creating an aerodynamic air bearing effect (e.g. configured as a spiral groove bearing with a journal form).

In yet another embodiment, the at least one cutting edge 105, 205 can have a chip breaker to improve swarf breaking and resultantly, swarf evacuation. Many geometries of chip breaker are already used on cutting tools. In examples, the cutting edge 105, 205 may include steps or notches to reduce swarf width. In examples, there may be chip breaking fixtures on the rake face of the tool or the cutting edge 105, 205 may include steps or notches to reduce swarf width.

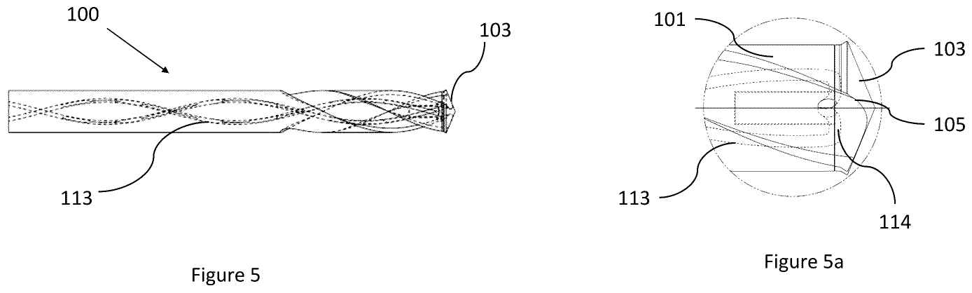

In FIGS. 1-6 the machining tool 100, 200 is configured to deliver cutting fluid in the region of the cutting edge 105, 205 via at least one fluid outlet 113. In the example of FIGS. 6a to 6c a fluid path can be formed in the shroud 206 and connected to a fluid outlet in the cutting head 203. The cutting fluid can be, for example, a cutting oil, a cryogenic cutting fluid, or a fluid that is held in the supercritical state upstream of the fluid outlet 113. The diameter of the outlet when using fluid in a supercritical state is between 0.1 and 0.3 mm, smaller than upstream pipe diameters, to create a restriction to maintain upstream pressure and allow a rapid pressure drop. When other fluids are used, the diameter of the outlet can be larger as the rapid pressure drop is not needed. It is understood that larger holes provide less restriction to flow and a higher flow rate. Optionally, the at least one fluid outlet 113 runs through the coupling 102, the cutting head 103 and exits near the cutting edge 105, 205, ejecting the fluid in the proximal direction as shown in FIGS. 1-4. In an alternative embodiment, as shown in FIG. 5, the at least one fluid outlet is facing away from the drilling area, towards the distal end. This is achieved by means of a u-turn 114 in the fluid outlet 113. Facing the at least one fluid outlet away from the drilling area (rearward) assists with swarf removal and cooling, with minimal disturbance of the interfay. In another example, the fluid outlet 113 and the u-turn 114 may be formed in the removable cutting head 201 shown in FIG. 6a-6c. In another example, the fluid outlet 113 and the u-turn 114 may be formed partly by the main body 101 of the tool and partly by a removable cutting head. Forming the fluid outlet 113 and u-turn 114 at least partly in a removable cutting head, rather than in the main body 101 of the tool, may make it easier to manufacture. Facing the at least one cutting fluid outlet 113 at least partly towards the distal end reduces the risk of contamination since the fluid flow is directed away from the interfay, this has the added benefit of reducing the pressure in the opening, assisting in closing the gap between components.

The following method can be used for creating an opening in a multi-layered material.

As a first step, a multi-layered material is provided. It is understood that the term “multi-layered” comprises at least two layers of materials, the layers may share or have differing chemical and mechanical properties. By way of example, the layers can be without limitation carbon fibre reinforced polymer, aluminium alloys, stainless steel, titanium and titanium alloys etc. It is also understood that layers can be repeated, for example, the material can comprise two or more layers of carbon fibre separated by the aluminium alloy, or vice versa. It is also understood that the layers may have a sealant between them.

At the next step the machining tool 100 is provided, said tool being rotated about its axis and advanced towards the workpiece to create the opening.

At the next step the tool 100 creates the opening through the layers of multi-layered material. The shroud that at least partially covers the region between the coupling 102 and cutting edge 105 acts as a protector for the opening, thus creating clean and contaminant free opening without the surface defects normally caused by the swarf passing through the opening.

As the final step, when the opening is created the tool is extracted from the opening.

In this way the need for a minimised gap between components to restrict interfay contamination is reduced.

Optionally, the machining tool can be vibrated. Vibration assisted drilling uses controlled vibration, typically in the axial direction, to aid swarf breaking in metallic. This could be ultrasonic vibration as well as low frequency vibration assisted drilling (Mitis systems, https://www.mitis.fr/).

Further optionally, it is possible to use localised clamping to minimise gaps between the layers during drilling. This may for example, be provided by a pressure foot, adjacent final fasteners, disposable rivets, C-clamps or electromagnetic clamping.

In an alternative embodiment, vacuum extraction can be applied during the process of creating the opening. Vacuum extraction is particularly advantageous when using the cutting fluid to assist chip and swarf evacuation.

It is understood that the method described above can also be used on pre-holes and defective holes, thus allowing to use re-working to correct the sub-standard openings without the need to discard the machined part. It will be clear to the skilled person that some prefabricated components may be supplied with pre-holes as standard which subsequently require further machining to get them to the correct size. A pre-hole may be present if the assembly process utilises temporary fasteners. Once the temporary fastener is removed from a pre-hole, the pre-hole will be machined to size and a permanent fastener applied. A pre-hole may be present as a result of a malfunction during the primary machining step resulting in the hole being revisited and usually oversized.

The method and the machining tools described above can be particularly advantageous for use in one-way assembly, however many different cutting tool technologies could be applied to the method and machining tool described.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A machining tool for creating openings in a multi-layered material, the tool comprising:
a main body comprising a coupling, and
a cutting head at one end thereof, the cutting head having a cutting diameter, at least one cutting edge and at least one outer corner; and
a shroud having an average shroud wall thickness, a length, a distal end, a proximal end having a front edge, an internal shroud diameter and an external shroud diameter, said shroud covering at least part of the region between the coupling and cutting edge and configured to direct contaminants away from the opening,
wherein the cutting diameter is greater than the external shroud diameter at the proximal end.

2. A machining tool according to claim 1, wherein the internal shroud diameter increases towards the proximal end such that the shroud comprises a taper that is tapered in the direction of the cutting head.

3. The tool of claim 2, wherein the taper has a chamfer, a bevel or a fillet.

4. The tool of claim 1, wherein the cutting head and the shroud are integral with the main body.

5. The tool of claim 1, wherein the cutting head, the shroud and the main body are formed as a multipiece arrangement.

6. The tool of claim 5, wherein the cutting head is a replaceable cutting head, wherein the replaceable cutting head is attachable to the shroud.

7. The tool of claim 1, wherein the front edge of the shroud is located proximate to the outer corner of the cutting head in an axial direction along the tool.

8. The tool of claim 1, wherein the shroud covers the region located less than 1 mm axially from the at least one outer corner of the tool and wherein the region is circumferentially aligned with the at least one outer corner of the tool.

9. The tool of claim 1, wherein an axial offset between the at least one outer corner of the tool and the front edge of the shroud is less than 1 mm, preferably less than 0.6 mm, more preferably less than 0.3 mm.

10. The tool of claim 1, wherein the outer diameter of the shroud at the proximal end is less than 0.16 mm smaller than the cutting diameter, preferably less than 0.08 mm, more preferably less than 0.03 mm.

11. The tool of claim 1, wherein the shroud covers the region less than 0.6 mm from the cutting edge in any direction, preferably less than 0.3 mm.

12. The tool of claim 1, wherein the internal shroud diameter increases towards the distal end.

13. The tool of claim 1, wherein the external shroud diameter at the proximal end is greater than an external shroud diameter at the distal end.

14. The tool of claim 1 wherein the cutting diameter of the tool is less than 50 mm.

15. The tool of claim 1, wherein the average shroud wall thickness is less than 0.3 mm.

16. The tool of claim 1, wherein the shroud further comprises an outer wall comprising a patterned surface, for example a rough, abrasive surface.

17. The tool of claim 16, wherein the patterned surface of the outer wall comprises a plurality of depressions or grooves.

18. The tool of claim 1, further comprising at least one fluid outlet located by the cutting edge, wherein said at least one fluid outlet is configured to deliver a cutting fluid and to point towards the distal end of the tool.

19. The tool of claim 1, wherein the cutting fluid is in a supercritical state.

20. The tool of claim 1 further comprising at least one extraction channel extending from the proximal end of the tool and at least partly through the internal diameter of the shroud.

21. The tool of claim 1 further comprising a web and at least one flute, said flute being at least partly enclosed by the shroud.

22. The tool of claim 1 where the cutting head has the geometry of a drill or a reamer.

23. The tool of claim 1, further comprising a countersink cutter spaced from the cutting head in a distal direction of the tool.

24. A method of creating an opening in a multi-layered material comprising the steps of
Providing the multi-layered material;
Providing a tool according to any of the preceding claims;
Performing a machining operation using the tool to create the opening, such that contaminants are directed away from the opening during the machining operation,
wherein the opening is provided substantially free from contaminants.

25. The method of claim 24, wherein the multi-layered material comprises a plurality of components arranged in a stack.

26. The method of claim 25, wherein at least one of the plurality of components comprises a fibre-reinforced polymer material.

27. The method of claim 24, wherein controlled vibration, such as that provided in vibration assisted machining, is applied to the machining tool.

28. The method of claim 24 further comprising a step of localised clamping to compress the layers of the multi-layered material.

29. The method of claim 24 further comprising the step of vacuum extraction of the contaminants.

30. The method claim 24, wherein the step of performing a machining operation is performed to widen a pre-existing opening such as a pre-hole or a defective hole.

31. (canceled)
